(19) United States
(12) Patent Application Publication
(10) Pub. No.: US 2025/0347851 A1
(43) Pub. Date: Nov. 13, 2025

(54) OPTICAL DEVICE, OPTICAL TRANSMITTER, AND OPTICAL RECEIVER

(71) Applicant: FUJITSU OPTICAL COMPONENTS LIMITED, Kawasaki-shi (JP)

(72) Inventor: Akira OKA, Kawasaki (JP)

(73) Assignee: FUJITSU OPTICAL COMPONENTS LIMITED, Kawasaki-shi (JP)

(21) Appl. No.: 19/060,063

(22) Filed: Feb. 21, 2025

(30) Foreign Application Priority Data
May 13, 2024 (JP) 2024-078209

(51) Int. Cl. G02B 6/28; G02B 6/42; H04B 10/40; H04B 10/516; H04B 10/67

(52) U.S. Cl. CPC G02B 6/2852; G02B 6/4286; H04B 10/40; H04B 10/516; H04B 10/67

(57) ABSTRACT

An optical device includes a first coupler, a second coupler, and a monitor. The first coupler includes a first input port, a first bar port, and a first cross port, and largely taps signal light on a short wavelength side from the first input port to the first bar port. The second coupler includes a second input port, a second bar port, and a second cross port, and largely taps signal light on a long wavelength side from the second input port to the second cross port. The monitor is connected to one of the first bar port and the second cross port, and monitors signal light that is output from one of the first bar port and the second cross port.

### CROSS-REFERENCE TO RELATED APPLICATION

This application is based upon and claims the benefit of priority of the prior Japanese Patent Application No. 2024-078209, filed on May 13, 2024, the entire contents of which are incorporated herein by reference.

### FIELD

The embodiments discussed herein are related to an optical device, an optical transmitter, and an optical receiver.

### BACKGROUND

For example, with use of a coherent optical communication technology, high-speed and high-capacity communication is enabled in an optical fiber communication network. In an optical transceiver for coherent optical communication, power of signal light that is guided through an optical waveguide of an optical device that is used in the optical transceiver is monitored, and control on an internal circuit, such as adjustment of an attenuation amount, is performed based on a monitoring result. Therefore, the optical transceiver needs optical tap for tapping a part of the signal light that is guided through the optical waveguide.

As a method for realizing the optical tap, for example, a tapered directional coupler is proposed (for example, International Publication Pamphlet No. 2016/052343). In an optical device disclosed in International Publication Pamphlet No. 2016/052343, SiO₂ of a Buried Oxide (BOX) layer on a Silicon-On-Insulator (SOI) wafer substrate is adopted as a lower clad and Si in the SOI layer is etched to obtain a core of an arbitrary shape. Furthermore, SiO₂ is deposited from above to form an upper clad, so that an optical device of a silicon photonics technology is manufactured.

International Publication Pamphlet No. 2016/052343 discloses a device that includes two tapered waveguides that are arranged parallel to each other, where optical power of light that is input to one of the tapered waveguides gradually transitions to the other one of the tapered waveguides along a traveling direction. This is because an evanescent wave is used, where light penetrates to outside of the core. Furthermore, this is because effective refractive indices of light guided through the respective tapered waveguides coincide with each other at certain cross sections (perpendicular to the traveling direction of the light) in the two tapered waveguides, and a magnitude relationship of the effective refractive indices of light guided through the two tapered waveguides is inverted between a front side and a back side of the cross sections.

In International Publication Pamphlet No. 2016/052343, by taking advantage of characteristics in which an evanescent wave of TM0 more widely penetrates through the core as compared to TE0, it is possible to allow transition of only TM0 (almost 100% of TM) to the adjacent other tapered waveguide and prevent transition of TE0 light as much as possible. As a result, it is possible to enable polarization separation between TM0 and TE0 in the optical device disclosed in International Publication Pamphlet No. 2016/052343. This is because optical coupling with the adjacent tapered waveguide is strengthened with an increase in penetration of light due to the evanescent wave, and characteristics of enabling transition at almost 100% with a shorter taper length are used. Furthermore, this is because characteristics of enabling only a little transition with the same taper length when optical coupling with the adjacent tapered waveguide is weakened is used.

Here, TE0 is light that has a maximum effective refractive index in a TE mode in which an electric field component that is horizontal to the substrate is dominant, and TM0 is light that has a maximum effective refractive index in a TM mode in which an electric field component that is perpendicular to the substrate is dominant. Here, when operation at the time of input of TE0 is paid attention to, a part of input power transitions to the adjacent other tapered waveguide, but the rest of power does not transition, remains in the one tapered waveguide, and is optically tapped.

In the optical device, for example, when a wavelength of signal light is 1520 nanometers (nm) and a tap rate that indicates a rate at which a part of the signal light that is guided by the adjacent waveguide is tapped is about 2.2%, the tap rate reaches about 3.5% if the wavelength is 1580 nm. In other words, in the conventional optical device, when the wavelength of the guided signal light changes, the tap rate also changes. This is because penetration of light due to an evanescent wave increases with an increase in the wavelength and optical coupling with the adjacent other tapered waveguide is strengthened.

In other words, in an optical device that implements an optical tap function by enabling optical coupling from the one tapered waveguide to the adjacent other tapered waveguide via an evanescent wave, the optical coupling is strengthened with an increase in the wavelength, so that the tap rate changes in accordance with a change in the wavelength. Meanwhile, for the sake of simplicity of explanation, the tapered directional coupler is described as one example, but the tap rate also changes with a change in the wavelength even in a normal directional coupler that is not tapered.

Patent Literature 1: International Publication Pamphlet No. 2016/052343

Patent Literature 2: Japanese Laid-open Patent Publication No. H8-234032

Patent Literature 3: Japanese Laid-open Patent Publication No. H4-212108

Patent Literature 4: U.S. Patent Application Publication No. 2018/0372957

Patent Literature 5: U.S. Patent Application Publication No. 2021/0181419

However, in a coherent optical transceiver, a wavelength range of signal light needs work in a wide range in order to cope with wavelength multiplexing communication, so that the tap rate largely changes in accordance with a change in the wavelength of the signal light. Therefore, there is a need for an optical device that is able to prevent a change of the tap rate even when the wavelength of the signal light is changed.

### SUMMARY

According to an aspect of an embodiment, an optical device includes a first coupler, a second coupler and a monitor. The first coupler includes a first input port, a first bar port that is located in a bar direction with respect to the first input port, and a first cross port that is located in a cross direction with respect to the first input port. The first coupler largely taps signal light on a short wavelength side from the first input port to the first bar port. The second coupler includes a second input port, a second bar port that is located in a bar direction with respect to the second input port, and a second cross port that is located in a cross direction with respect to the second input port. The second coupler largely taps signal light on a long wavelength side from the second input port to the second cross port. The monitor is connected to one of the first bar port and the second cross port, and monitors the signal light that is output from one of the first bar port and the second cross port.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining an example of an optical device of a first embodiment;

FIG. 2 is a schematic plan view illustrating an example of a first coupler;

FIG. 3 is a schematic cross-sectional view illustrating an example of a portion taken along a line A-A illustrated in FIG. 2;

FIG. 4 is a diagram for explaining an example of a relationship between a wavelength and a tap rate of the first coupler;

FIG. 5 is a schematic plan view illustrating an example of a second coupler;

FIG. 6 is a schematic cross-sectional view illustrating an example of a portion taken along a line B-B illustrated in FIG. 5.

FIG. 7 is a diagram for explaining an example of a relationship between a wavelength and a tap rate of the second coupler;

FIG. 8 is a diagram for explaining an example of a relationship between a wavelength and a tap rate of the optical device;

FIG. 9 is a schematic plan view illustrating an example of a coupler of a comparative example;

FIG. 10 is a schematic cross-sectional view illustrating an example of a portion taken along a line C-C illustrated in FIG. 9;

FIG. 11 is a diagram for explaining an example of a relationship between a wavelength and a tap rate of the coupler of the comparative example;

FIG. 12 is a diagram for explaining an example of an optical device of a second embodiment;

FIG. 13 is a diagram for explaining an example of an optical device of a third embodiment; and

FIG. 14 is a diagram for explaining an example of an optical transceiver according to one embodiment.

### DESCRIPTION OF EMBODIMENTS

Preferred embodiments of the present invention will be explained with reference to accompanying drawings. Meanwhile, the disclosed technology is not limited by the embodiments below. In addition, the embodiments described below may be combined appropriately as long as no contradiction is derived.

### (a) First Embodiment

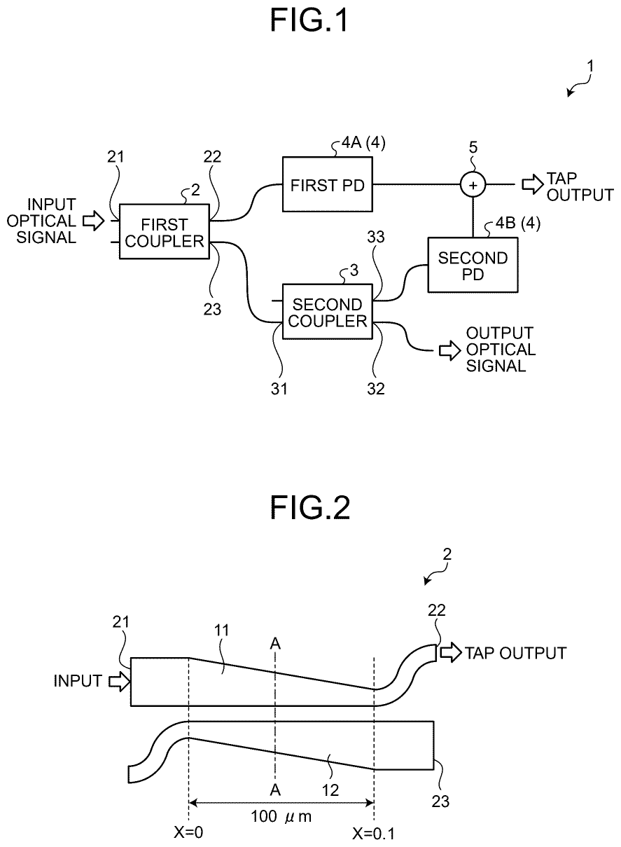

FIG. 1 is a diagram for explaining an example of an optical device 1 of a first embodiment. The optical device 1 illustrated in FIG. 1 includes a first coupler 2, a second coupler 3, a first Photo Detector (PD) 4A (4), a second PD 4B (4), and an adder 5. The first coupler 2 includes a first input port 21, a first bar port 22 that is located in a bar direction with respect to the first input port 21, and a first cross port 23 that is located in a cross direction with respect to the first input port 21. The first coupler 2 is, for example, a 2×2 coupler in which a part of signal light at a short wavelength is mainly tapped from the first input port 21 to the first bar port 22. In other words, the first coupler 2 largely taps a signal light on a short wavelength side from the first input port 21 to the first bar port 22 as compared to signal light on a long wavelength side.

The second coupler 3 includes a second input port 31, a second bar port 32 that is located in a bar direction with respect to the second input port 31, and a second cross port 33 that is located in a cross direction with respect to the second input port 31. The second coupler 3 is, for example, a 2×2 coupler in which a part of signal light at a long wavelength is mainly tapped from the second input port 31 to the second cross port 33. In other words, the second coupler 3 largely taps signal light on a long wavelength side from the second input port 31 to the second cross port 33 as compared to signal light on a short wavelength side.

The first PD 4A is a monitor unit that is connected to the first bar port 22 of the first coupler 2 and performs current conversion on a part of the signal light that is tapped to the first bar port 22. The second PD 4B is a monitor unit that is connected to the second cross port 33 of the second coupler 3 and performs current conversion on a part of the signal light that is tapped to the second cross port 33.

The adder 5 adds a current value that adopts the short wavelength from the first PD 4A as a dominant wavelength and a current value that adopts the long wavelength from the second PD 4B as a dominant wavelength, and outputs the added current value, as monitor output, to a control circuit via an analog-to-digital (A/D) converter (not illustrated).

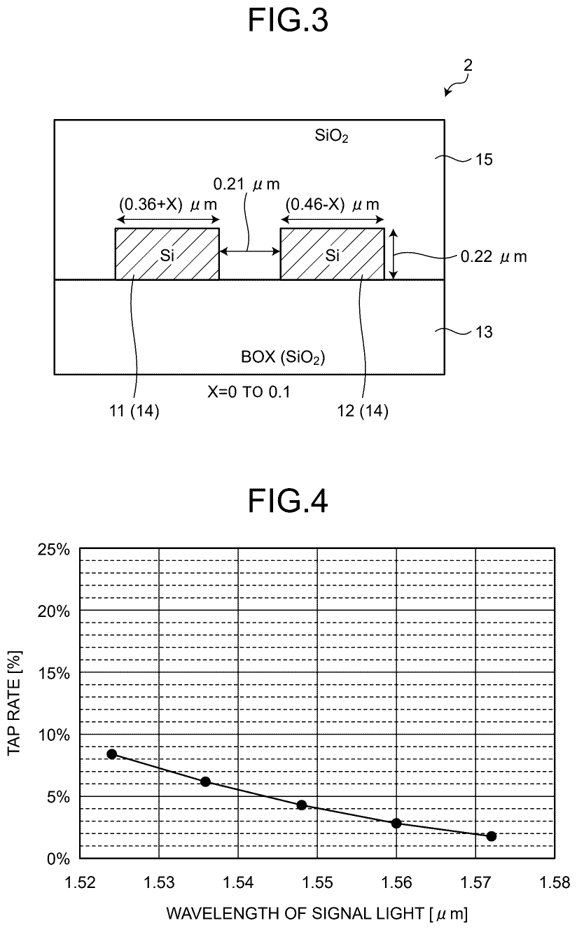

FIG. 2 is a schematic plan view illustrating an example of the first coupler 2, FIG. 3 is a schematic cross-sectional view illustrating an example of a portion taken along a line A-A illustrated in FIG. 2. The first coupler 2 is a tapered directional coupler that includes, as the first input port 21, a first waveguide 11 for inputting signal light, and a second waveguide 12 that is located adjacent to the first waveguide 11. The first waveguide 11 is, for example, a tapered waveguide in which a waveguide width decreases from an input stage toward an output stage. The second waveguide 12 is, for example, a tapered waveguide in which a waveguide width increases from the input stage toward the output stage.

The first coupler 2 illustrated in FIG. 3 includes a Si substrate (not illustrated), a lower clad layer 13 that is laminated on the Si substrate and that is made of, for example, SiO₂ or the like, and the first waveguide 11 and the second waveguide 12 that serve as a core 14, that are formed on the lower clad layer 13, and that are made of, for example, Si or the like. Further, the first coupler 2 includes an upper clad layer 15 that is laminated on the lower clad layer 13, the first waveguide 11, and the second waveguide 12 and that is made of, for example, SiO₂ or the like. A waveguide width of the first waveguide 11 illustrated in FIG. 3 is, for example, (0.36+X) micrometers (μm), and a waveguide width of the second waveguide 12 is, for example, (0.46+X) μm. Meanwhile, X is 0 to 0.1 μm. Furthermore, heights of the first waveguide 11 and the second waveguide 12 are, for example, 0.22 μm. Moreover, an interval of a parallel section between the first waveguide 11 and the second waveguide 12 is, for example, 0.21 μm.

The parallel section in which the first waveguide 11 and the second waveguide 12 are arranged parallel to each other in the first coupler 2 has a start point and an end point. The waveguide width of the first waveguide 11 at the start point and the waveguide width of the second waveguide 12 at the end point are set to the same. Further, the waveguide width of the first waveguide 11 at the end point and the waveguide width of the second waveguide 12 at the start point are set to the same. Furthermore, the first waveguide 11 and the second waveguide 12 have point symmetrical structures. The parallel section is 100 μm. An S-bend that is included in the first bar port of the first waveguide 11 and an S-bend that is included in the input stage of the second waveguide 12 have diameters of 60 μm.

In the tapered directional coupler, for example, when a waveguide length corresponding to the parallel section is shorter than a reference length, only a part of signal light that is guided through the first waveguide 11 transitions from the first waveguide 11 to the second waveguide 12. In contrast, in the tapered directional coupler, when the waveguide length corresponding to the parallel section is longer than the reference length, signal light that is guided through the first waveguide 11 transitions to the second waveguide 12. In the case where the waveguide length corresponding to the parallel section is equal to the reference length, a ratio at which power of the signal light transitions from the first waveguide 11 to the second waveguide 12 increases with an increase in the wavelength with which a percentage of the evanescent wave is increase.

In the first coupler 2, the waveguide length of the parallel section is set to long, such as 100 μm, so that more and more power of the signal light transitions from the first waveguide 11 to the second waveguide 12, and power of the signal light that can be tapped from the first bar port 22 is reduced. In the first coupler 2, transition to the second waveguide 12 more easily occurs with an increase in the wavelength of the signal light that is guided in the first waveguide 11, but a short wavelength remains in the first waveguide 11; therefore, at an output end of the first bar port 22, power of the signal light at the short wavelength is tapped. As a result, the first coupler 2 outputs the signal light from the second waveguide 12 as the first cross port 23, and mainly taps the signal light at the short wavelength from the first waveguide 11 as the first bar port 22.

FIG. 4 is a diagram for explaining an example of a relationship between the wavelength and the tap rate of the first coupler 2. The tap rate of the first coupler 2 toward the first PD 4A side, that is, a ratio of optical power, which is tapped to the first bar port 22 that is connected at the side of the first PD 4A, to power of input signal light is calculated by the finite-difference time-domain method. A calculation result indicates that signal light at a short wavelength is mainly tapped to the first bar port 22 of the first coupler 2.

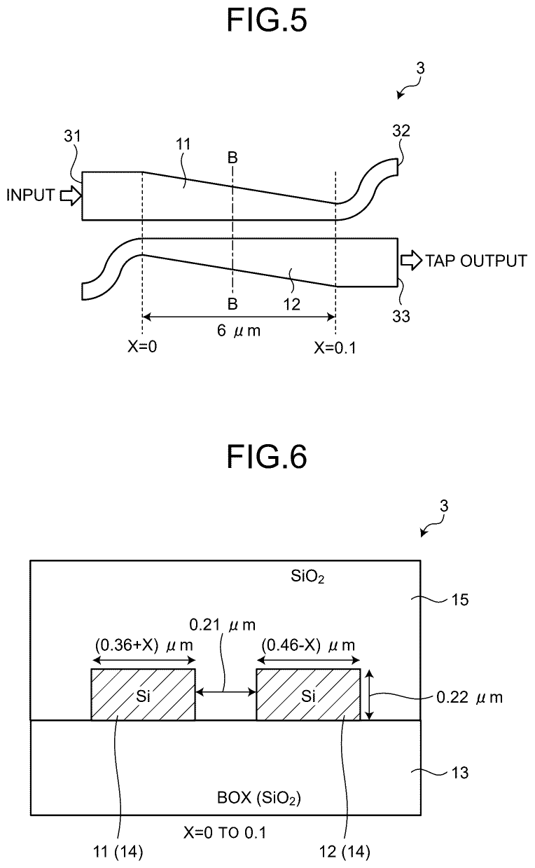

FIG. 5 is a schematic plan view illustrating an example of the second coupler 3, and FIG. 6 is a schematic cross-sectional view illustrating an example of a portion taken along a line B-B illustrated in FIG. 5. The second coupler 3 illustrated in FIG. 5 is a tapered directional coupler that includes, as the second input port 31, the first waveguide 11 for inputting signal light, and the second waveguide 12 that is located adjacent to the first waveguide 11. The first waveguide 11 is, for example, a tapered waveguide in which the waveguide width decreases from the input stage toward the output stage. The second waveguide 12 is, for example, a tapered waveguide in which the waveguide width increases from the input stage to the output stage.

The second coupler 3 illustrated in FIG. 6 includes a Si substrate (not illustrated), the lower clad layer 13 that is laminated on the Si substrate and that is made of, for example, SiO₂ or the like, and the first waveguide 11 and the second waveguide 12 that serve as the core 14, that are formed on the lower clad layer 13, and that are made of, for example, Si or the like. The second coupler 3 includes the upper clad layer 15 that is laminated on the lower clad layer 13, the first waveguide 11, and the second waveguide 12 and that is made of, for example, SiO₂ or the like. The waveguide width of the first waveguide 11 illustrated in FIG. 6 is, for example, (0.36+X) μm, and the waveguide width of the second waveguide 12 is, for example, (0.46+X) μm. Meanwhile, X is 0 to 0.1 μm. Furthermore, the heights of the first waveguide 11 and the second waveguide 12 are, for example, 0.22 μm. Moreover, the width of the parallel section between the first waveguide 11 and the second waveguide 12 is, for example, 0.21 μm.

The parallel section in which the first waveguide 11 and the second waveguide 12 are arranged parallel to each other in the second coupler 3 has a start point and an end point. The waveguide width of the first waveguide 11 at the start point and the waveguide width of the second waveguide 12 at the end point are set to the same. Further, the waveguide width of the first waveguide 11 at the end point and the waveguide width of the second waveguide 12 at the start point are set to the same. Furthermore, the first waveguide 11 and the second waveguide 12 have point symmetrical structures. The parallel section is 6 μm. An S-bend that is included in the second bar port 32 of the first waveguide 11 and an S-bend that is included in the input stage of the second waveguide 12 have diameters of 60 μm.

In the case where the waveguide length corresponding to the parallel section is equal to the reference length, a ratio at which power of signal light transitions from the first waveguide 11 to the second waveguide 12 increases with an increase in the wavelength with which a percentage of the evanescent wave is increase. In the second coupler 3, when the waveguide length of the parallel section is reduced to 6 μm, transition of the power of the signal light from the first waveguide 11 to the second waveguide 12 becomes difficult, so that power of the signal light that can be tapped from the second cross port 33 is reduced. Therefore, in the second coupler 3, signal light that is guided through the first waveguide 11 is more easily leaked with an increase in the wavelength of the signal light, so that power of the signal light at a long wavelength is mainly tapped at the output end of the second cross port 33. As a result, the second coupler 3 outputs the signal light from the first waveguide 11 as the second bar port 32, and mainly taps the signal light at the long wavelength from the second waveguide 12 as the second cross port 33.

Originally, as for input of the first coupler 2 in the optical device 1, signal light at a plurality of wavelengths are not input simultaneously, but signal light is input in a wavelength unit among the plurality of wavelengths.

When signal light at a single wavelength is input, the first coupler 2 taps, from the first bar port 22, signal light that adopts a short wavelength as a dominant wavelength, and outputs, from the first cross port 23, the signal light that has transitioned from the first waveguide 11. Further, when the signal light that adopts the short wavelength as a dominant wavelength and that is tapped from the first bar port 22 is present, the first PD 4A performs current conversion on the signal light that adopts the short wavelength as a dominant wavelength, and outputs a current value that adopts the short wavelength as a dominant wavelength and that is obtained by the current conversion to the adder 5.

Furthermore, the second coupler 3 taps, from the second cross port 33, signal light that adopts a long wavelength as a dominant wavelength in the signal light that is input from the first cross port 23 of the first coupler 2, and outputs, from the second bar port 32, remaining signal light. Moreover, when the signal light that adopts the long wavelength as a dominant wavelength and that is tapped from the second cross port 33 is present, the second PD 4B performs current conversion on the signal light that adopts the long wavelength as a dominant wavelength, and outputs a current value that adopts the long wavelength as a dominant wavelength and that is obtained by the current conversion to the adder 5. Furthermore, the adder 5 outputs, as monitor output, the current value that adopts the short wavelength as a dominant wavelength when the signal light that adopts the short wavelength as a dominant wavelength is present, and outputs, as monitor output, the current value that adopts the long wavelength as a dominant wavelength when the signal light that adopts the long wavelength as a dominant wavelength is present.

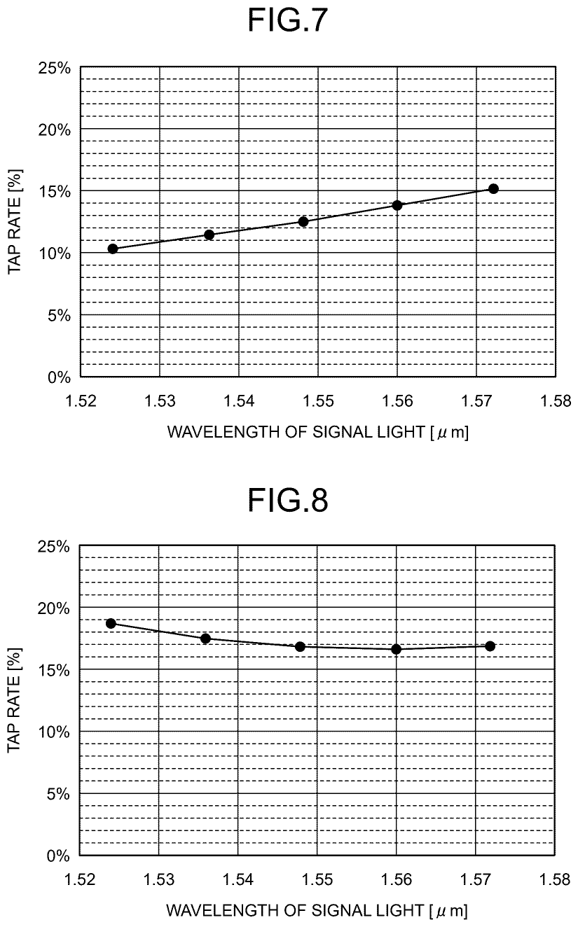

FIG. 7 is a diagram for explaining an example of a relationship between the wavelength and the tap rate of the second coupler 3. The tap rate of the second coupler 3 toward the second PD 4B side, that is, a ratio of optical power, which is output to the second cross port 33 that is connected at the side of the second PD 4B, to power of input light is calculated by the finite-difference time-domain method. A calculation result indicates that the signal light that adopts the long wavelength as a dominant wavelength is tapped at the second cross port 33 of the second coupler 3.

The adder 5 of the optical device 1 adds a certain current value, which corresponds to the signal light that adopts the short wavelength as a dominant wavelength and that is tapped at the first bar port 22 of the first coupler 2, and another current value, which corresponds to the signal light that adopts the long wavelength as a dominant wavelength and that is tapped at the second cross port 33 of the second coupler 3. FIG. 8 is a diagram for explaining an example of a relationship between the wavelength and the tap rate of the optical device 1. In the optical device 1, when signal light that is input to the first coupler 2 has a wavelength range of, for example, 1.524 μm to 1.572 μm, a minimum tap rate is 16.6% and a maximum tap rate is 18.7%, so that a ratio between the minimum tap rate and the maximum tap rate is 1.12. In other words, the optical device 1 is able to precent a change of the tap rate even when the wavelength is changed.

Furthermore, an arrival time from when signal light is input to the first input port 21 of the first coupler 2 till when a current value arrives at the adder 5 via the first PD 4A will be referred to as a first arrival time D1. Moreover, an arrival time from when signal light is input to the first input port 21 till when a current value arrives at the adder 5 via the second coupler 3 and the second PD 4B will be referred to as a second arrival time D2. In the optical device 1, optical wiring and electrical wiring are adjusted such that the first arrival time D1 and the second arrival time D2 approximately coincide with each other. Specifically, lengths of the optical wiring and the electrical wiring are determined such that a sum of the arrival time of light from input to the first coupler 2 till arrival at each of the PDs 4 and an arrival time of electricity from each of the PDs 4 to the adder 5 as a portion in which currents are added is equalized with respect to all of PD currents. As a result, when the PD currents are added, it is possible to prevent speed deterioration as the PD 4 due to a delay of pulse of each of the PD currents.

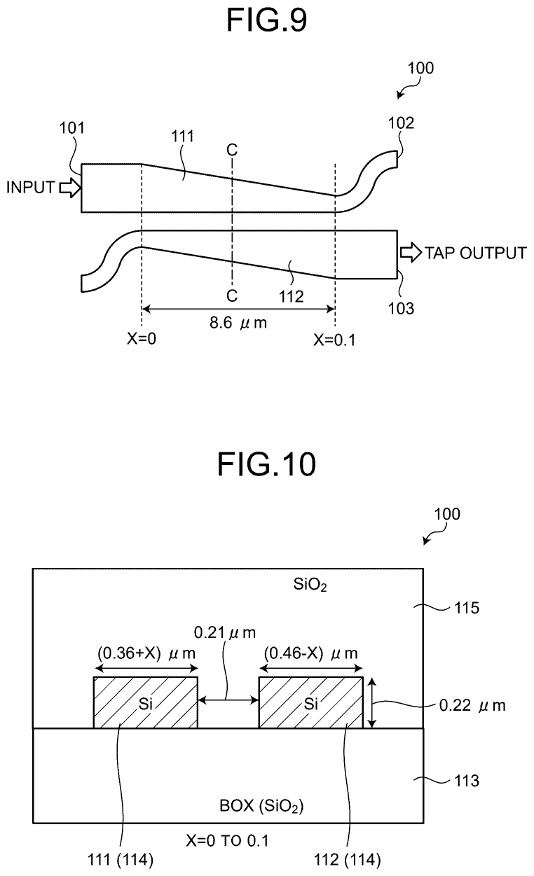

A difference between characteristics of the first coupler 2 and the second coupler 3 and characteristics of a coupler 100 of the comparative example will be described below. FIG. 9 is a schematic plan view illustrating an example of the coupler 100 of the comparative example, and FIG. 10 is a schematic cross-sectional view illustrating an example of a portion taken along a line C-C illustrated in FIG. 9. The coupler 100 illustrated in FIG. 9 is a tapered directional coupler that includes a first waveguide 111 for inputting signal light, and a second waveguide 112 that is located adjacent to the first waveguide 111. The coupler 100 includes an input port 101, a bar port 102 and a cross port 103.

The coupler 100 illustrated in FIG. 10 includes a Si substrate (not illustrated), a lower clad layer 113 that is laminated on the Si substrate, and the first waveguide 111 and the second waveguide 112 that serve as a core 114 and that are formed on the lower clad layer 113. Further, the coupler 100 includes an upper clad layer 115 that is laminated on the lower clad layer 113, the first waveguide 111, and the second waveguide 112. A waveguide width of the first waveguide 111 is, for example, (0.36+X) μm, and a waveguide width of the second waveguide 112 is, for example, (0.46+X) μm. Meanwhile, X is 0 to 0.1 μm. Furthermore, heights of the first waveguide 111 and the second waveguide 112 are, for example, 0.22 μm. Moreover, a width of the parallel section between the first waveguide 111 and the second waveguide 112 is, for example, 0.21 μm. The parallel section is 8.6 μm. An S-band that is located in an output stage of the first waveguide 111 and an S-bend that is located in an input stage of the second waveguide 112 have diameters of 60 μm.

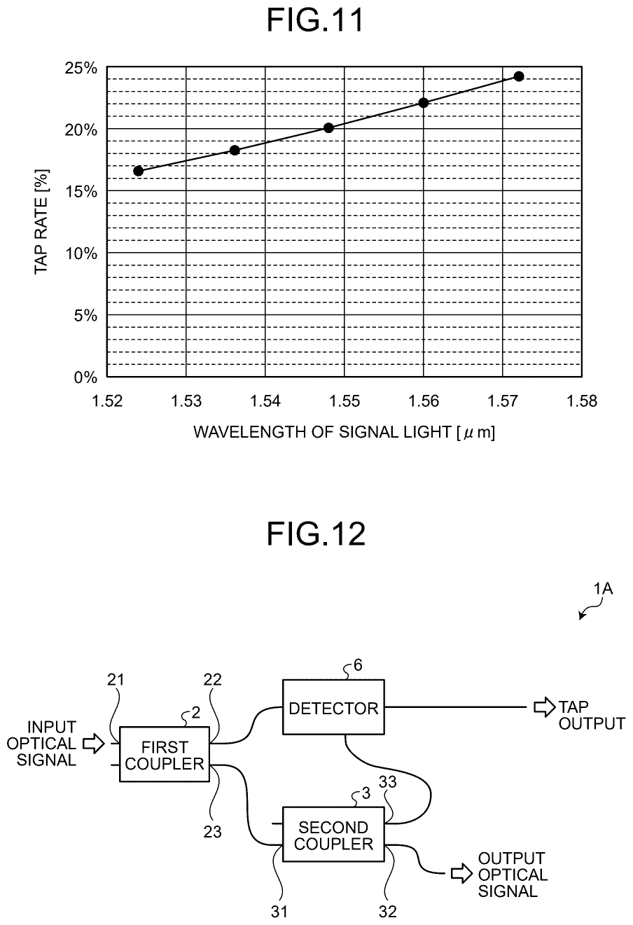

In the coupler 100, a tap rate that indicates a rate at which a part of signal light is tapped from the first waveguide 111 or the second waveguide 112 changes in accordance with a change in the wavelength of the guided signal light. FIG. 11 is a diagram for explaining an example of a relationship between a wavelength and a tap rate of the coupler 100 of the comparative example. In the coupler 100, when signal light to be input has a wavelength range of, for example, 1.524 μm to 1.572 μm, a minimum tap rate is 16.6% and a maximum tap rate is 24.2%, so that a ratio between the minimum tap rate and the maximum tap rate is 1.45. In other words, in the coupler 100, the tap rate is largely changed when the wavelength is changed.

Therefore, in the case of the wavelength range of 1.524 μm to 1.572 μm, the ratio between the minimum tap rate and the maximum tap rate is 1.45 in the coupler 100 of the comparative example, whereas the ratio between the minimum tap rate and the maximum tap rate is 1.12 in the optical device 1 according to the embodiment. Therefore, in the optical device 1 according to the present embodiment, it is possible to prevent a change of the tap rate even when the wavelength of the signal light is changed.

In contrast, in the coupler 100 of the comparative example, because the tap rate is largely changed when the wavelength of the guided signal light is changed, an analog-to-digital (A/D) converter for perform digital conversion on the current value of the signal light that is tapped by the coupler 100 needs a wide dynamic range, which increases quantization noise.

In contrast, in the optical device 1 of the first embodiment, it is possible to prevent a change of the tap rate even when the wavelength of the guided signal light is changed, so that the A/D converter does not need a wide dynamic range, and it is possible to reduce quantization noise when a bit number at the time of quantization is set to the same. As a result, the technology is useful for an A/D converter that is used in an optical transceiver that operates when the signal light has a wide wavelength range.

In the optical device 1 of the first embodiment, by combining the first coupler 2 that can easily tap the signal light at the short wavelength and the second coupler 3 that can easily tap the signal light at the long wavelength and adding current values of light that are tapped by the respective couplers, it is possible to realize tapping with small wavelength dependence.

The first coupler 2 and the second coupler 3 take advantages of characteristics in which optical coupling is performed via an evanescent wave and the tap rate increases on the long wavelength side as compared to the short wavelength side. In the first coupler 2, the first bar port 22 is connected to the first PD 4A to mainly tap light on the short wavelength side, and, in the second coupler 3, the second cross port 33 is connected to the second PD 4B to mainly tap light on the long wavelength side. By subsequently adding output from the first PD 4A and output from the second PD 4B, it is possible to realize tapping with small wavelength dependence.

The example has been described in which the first input port 21 of the first coupler 2 is adopted as input of the optical device 1 of the first embodiment, and the first cross port 23 of the first coupler 2 and the second input port 31 of the second coupler 3 are connected to each other. However, embodiments are not limited to this example. For example, it may be possible to adopt the second input port 31 of the second coupler 3 as input of the optical device 1 and connect the second bar port 32 of the second coupler 3 and the first input port 21 of the first coupler 2, and appropriate modification may be made.

The example has been described in which the first coupler 2 and the second coupler 3 are 2×2 couplers, but a 1×2 coupler with at least single input is satisfactory, and appropriate modification may be made.

The first coupler 2 and the second coupler 3 need not always have the cross-sectional shapes as illustrated in FIG. 3 and FIG. 6, and appropriate modification may be made. For example, by adjusting a cross-sectional shape of a different waveguide, such as a rib waveguide, other than the rectangular waveguide, it is possible to increase a degree of freedom in design of the tap rate and the wavelength dependence.

Furthermore, in the first coupler 2 and the second coupler 3, the first waveguide 11 and the second waveguide 12 need not always be linearly tapered waveguides as illustrated in FIG. 2 and FIG. 5, and appropriate modification may be made. The first waveguide 11 and the second waveguide 12 may be configured such that, for example, widths are changed in a quadratic curve manner with respect to a light traveling direction, a different tapered structure may be connected in the middle of the waveguides, or a linear waveguide, that is, a non-tapered straight line, may be connected. Moreover, one of the waveguides need not always be tapered. In any case, it is clear that optical coupling due to the evanescent wave is maintained.

Furthermore, the first coupler 2 and the second coupler 3 may be configured with normal directional couplers that are not tapered, and appropriate modification may be made. The normal directional coupler can easily be designed as compared to the tapered directional coupler, and is preferable from the viewpoint of simplification of design.

Meanwhile, the example has been described in which in the optical device 1 of the first embodiment includes the first PD 4A that is connected to the first bar port 22 of the first coupler 2 and the second PD 4B that is connected to the second cross port 33 of the second coupler 3. For example, the first bar port 22 and the second cross port 33 need not always be connected to the different PDs 4, and an embodiment that copes with this situation will be described below as a second embodiment.

### (b) Second Embodiment

FIG. 12 is a diagram for explaining an example of an optical device 1A of the second embodiment. Meanwhile, the same components as those of the optical device 1 of the first embodiment are denoted by the same reference symbols, and explanation of the same components and the same operation will be omitted. The optical device 1 of the first embodiment and the optical device 1A of the second embodiment are different in that the first PD 4A, the second PD 4B, and the adder 5 are configured by a single detector 6. The detector 6 is connected to the first bar port 22 of the first coupler 2 and is further connected to the second cross port 33 of the second coupler 3. The detector 6 multiplexes signal light at a short wavelength that is mainly tapped by the first bar port 22 and signal light at a long wavelength that is mainly tapped by the second cross port 33, performs current conversion on the multiplexed signal light, and outputs, as monitor output, a current value that is obtained by the current conversion. Meanwhile, the single detector is known as disclosed in Publication of Unexamined Application of United States Patent Specification No. 2019/0391006.

Furthermore, an arrival time from input of signal light to the first input port 21 of the first coupler 2 till arrival at the detector 6 will be referred to as a third arrival time D3. Moreover, an arrival time from input of signal light to the first input port 21 till arrival at the detector 6 via the second coupler 3 will be referred to as a fourth arrival time D4. In the optical device 1A, optical wiring and electrical wiring are adjusted such that the third arrival time D3 and the fourth arrival time D4 coincide with each other. Specifically, lengths of the optical wiring and the electrical wiring are determined such that a sum of the arrival time of light from input to the first coupler 2 till arrival at the detector 6 and an arrival time of electricity from conversion of light inside the detector 6 to a current till arrival at the portion in which the converted currents are added is approximately equalized with respect to all of PD currents. As a result, when the PD currents are added, it is possible to prevent speed deterioration as the PD in the detector 6 due to a delay of pulse of each of the PD currents. The detector 6 in the optical device 1A of the

second embodiment is connected to the first bar port 22 of the first coupler 2 and further connected to the second cross port 33 of the second coupler 3. Furthermore, the detector 6 multiplexes the signal light that adopts the short wavelength as a dominant wavelength and that is tapped by the first bar port 22 and the signal light that adopts the long wavelength as a dominant wavelength and that is tapped by the second cross port 33, and outputs, as monitor output, the current value that is obtained by the current conversion. As a result, it is possible to reduce the number of the PD elements as compared to the optical device 1 of the first embodiment, so that it is possible to contribute to reduction of a size of the optical device 1A.

Meanwhile, the example has been described in which the optical device 1 of the first embodiment includes the single first coupler 2 and the single second coupler 3, but embodiments are not limited to this example, and a different embodiment will be described below as a third embodiment. Meanwhile, the same components as those of the optical device 1 of the first embodiment are denoted by the same reference symbols, and explanation of the same components and the same operation will be omitted.

### (c) Third Embodiment

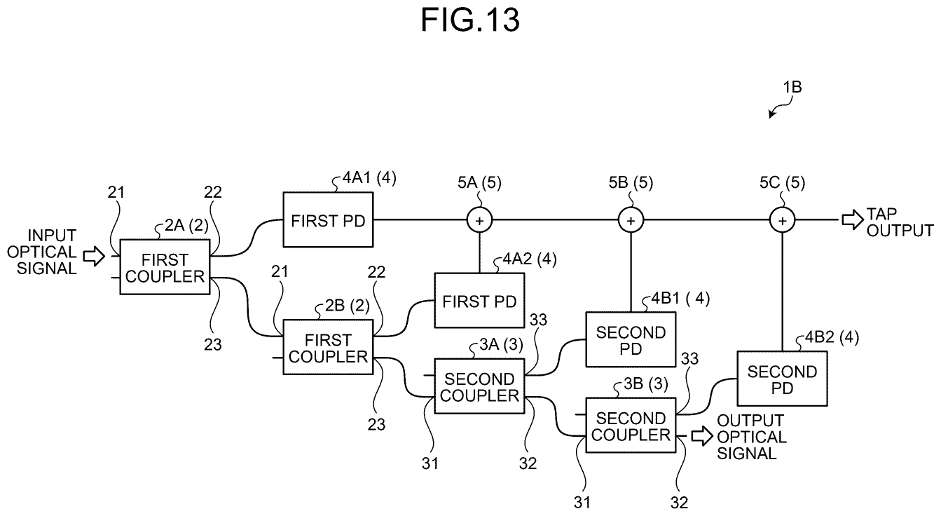

FIG. 13 is a diagram for explaining an example of an optical device 1B of the third embodiment. The optical device 1B illustrated in FIG. 13 includes two first couplers 2 (2A and 2B), two second couplers 3 (3A and 3B), two first PDs 4A (4A1 and 4A2), two second PDs 4B (4B1 and 4B2), and three adders 5 (5A, 5B, and 5C).

The one first coupler 2A is configured such that the first bar port 22 is connected to the one first PD 4A1 and the first cross port 23 is connected to the first input port 21 of the other first coupler 2B. The other first coupler 2B is configured such that the first bar port 22 is connected to the other first PD 4A2 and the first cross port 23 is connected to the second input port 31 of the one second coupler 3A.

The one first PD 4A1 performs current conversion on signal light that adopts a short wavelength that is tapped by the one first coupler 2A as a dominant wavelength, and inputs a current value that adopts the short wavelength as a dominant wavelength and that is obtained by the current conversion to the first adder 5A. Further, the other first PD 4A2 performs current conversion on signal light that adopts the short wavelength that is tapped by the other first coupler 2B as a dominant wavelength, and inputs the current value that adopts the short wavelength as a dominant wavelength and that is obtained by the current conversion to the first adder 5A. The first adder 5A adds the current value that adopts the short wavelength from the one first PD 4A1 as a dominant wavelength and the current value that adopts the short wavelength from the other first PD 4A2 as a dominant wavelength, and outputs the added current value to the second adder 5B.

The one second coupler 3A is configured such that the second cross port 33 is connected to the one second PD 4B1 and the second bar port 32 is connected to the second input port 31 of the other second coupler 3B. The other second coupler 3B is configured such that the second cross port 33 is connected to the other second PD 4B2.

The one second PD 4B1 performs current conversion on signal light that adopts a long wavelength that is tapped by the one second coupler 3A as a dominant wavelength, and inputs a current value that adopts the long wavelength as a dominant wavelength and that is obtained by the current conversion to the second adder 5B. Furthermore, the other second PD 4B2 performs current conversion on signal light that adopts the long wavelength that is tapped by the other second coupler 3B as a dominant wavelength, and inputs the current value that adopts the long wavelength as a dominant wavelength and that is obtained by the current conversion to the third adder 5C. The second adder 5B adds the current value that adopts the short wavelength from the first adder 5A as a dominant wavelength and the current value that adopts the long wavelength from the one second PD 4B1 as a dominant wavelength, and outputs the added current value to the third adder 5C. Moreover, the third adder 5C adds the current value from the second adder 5B and the current value that adopts the long wavelength from the other second PD 4B2 as a dominant wavelength, and performs monitor output.

Furthermore, an arrival time from when signal light is input to the first input port 21 of the first coupler 2A till when a current value arrives at the third adder 5C via the first PD 4A1, the first adder 5A, and the second adder 5B will be referred to as a first arrival time D1. Moreover, arrival time from when signal light is input to the first input port 21 till when a current value arrives at the third adder 5C via the other first coupler 2B, the other first PD 4A2, the first adder 5A and, the second adder 5B will be referred to as a second arrival time D2.

An arrival time from when signal light is input to the first input port 21 till when a current value arrives at the third adder 5C via the other first coupler 2B, the one second coupler 3A, the one second PD 4B1, and the second adder 5B will be referred to as a third arrival time D3. An arrival time from when signal light is input to the first input port 21 till when a current value arrives at the third adder 5C via the other first coupler 2B, the one second coupler 3A, the other second coupler 3B, and the second PD 4B2 will be referred to as a fourth arrival time D4.

In the optical device 1B, optical wiring and electrical wiring are adjusted such that the first arrival time D1, the second arrival time D2, the third arrival time D3, and the fourth arrival time D4 coincide with one another. Specifically, lengths of the optical wiring and the electrical wiring are determined such that a sum of the arrival time of light from input to the first coupler 2 till arrival at each of the PDs 4 and an arrival time of electricity from each of the PDs 4 to the third adder 5C as the portion in which the currents are added is approximately equalized with respect to all of PD currents. As a result, when the PD currents are added, it is possible to prevent speed deterioration as the PD 4 due to a delay of pulse of each of the PD currents.

In the optical device 1B of the third embodiment, the plurality of first couplers 2 and the plurality of second couplers 3 are used and current values of light that are tapped by the respective couplers are added, so that it is possible to realize tapping with low wavelength dependence.

Meanwhile, the example has been described in which the optical device 1B of the third embodiment includes the two first couplers 2 and the two second couplers 3, but embodiments are not limited to this example. For example, it may be possible to provide M first couplers 2 and N second couplers 3, and appropriate modification may be made. Meanwhile, for example, M and N may be set such that M≤1, N≤1, M≠N, or M=N, and appropriate modification may be made.

Meanwhile, a waveguide that is used for the first coupler 2 and the second coupler 3 may be, for example, a rib waveguide, a ridge waveguide, a rectangular waveguide, or a high mesa waveguide. The rib waveguide allows light to penetrate to slab portions, so that an influence of side wall roughening of a core is reduced and low-loss propagation is enabled; therefore, the rib waveguide is preferable. The rectangular waveguide enables strong optical confinement and reduces a loss even when a bend radius R is reduced; therefore, the rectangular waveguide is preferable. Furthermore, a low-loss bent waveguide may be adopted as the waveguide, and appropriate modification may be made.

A waveguide that is used for the first coupler 2 and the second coupler 3 may be a PLC in which both of a core and a clad are made of SiO₂, an InP waveguide, or a GaAs waveguide. It may be possible to adopt Si as a core, SiO₂ as a lower clad, and SiO₂ or air as an upper clad. It may be possible to adopt a Si waveguide, such as SiN. When the Si waveguide is adopted as the waveguide, a relative refractive index difference is increased and optical confinement is strengthened, so that it is possible to realize a bent waveguide that enables low loss even with the small bend radius R, that is, it is possible to reduce the size of the optical device, which is preferable.

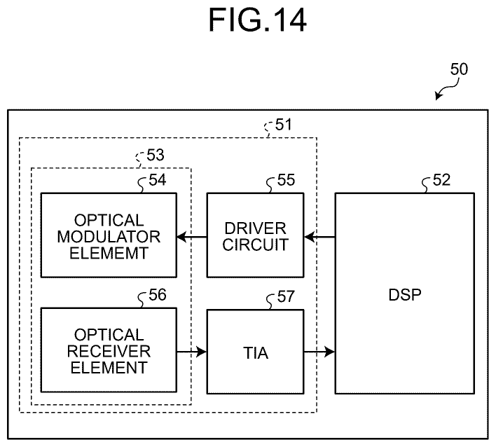

An optical transceiver 50 that adopts the optical device 1 according to one embodiment will be described below. FIG. 14 is a diagram for explaining an example of the optical transceiver 50 according to one embodiment. The optical transceiver 50 illustrated in FIG. 14 includes an optical transceiver 51 and a Digital Signal Processor (DSP) 52. The optical transceiver 51 includes an optical modulator element 54, a driver circuit 55, an optical receiver element 56, and a Transimpedance Amplifier (TIA) 57. The optical transceiver 51 includes an optical transmitter and an optical receiver. The DSP 52 controls the entire optical transceiver 51. The DSP 52 is an electrical component that performs digital signal processing, such as IQ modulation processing on a transmission signal and demodulation processing on a received signal.

The DSP 52 performs, for example, encoding or the

like on the transmission data, generates an electrical signal that includes the transmission data, and outputs the generated electrical signal to the driver circuit 55. The driver circuit 55 drives the optical modulator element 54 in accordance with an electrical signal from the DSP 52. The optical modulator element 54 performs optical modulation on signal light. The optical modulator element 54 incorporates therein, for example, the optical device 1. The optical transmitter incorporates therein at least the optical modulator element 54.

The optical receiver element 56 acquires signal light from received light by using an optical signal, and performs electrical conversion on the acquired signal light. The optical receiver element 56 incorporates therein, for example, the optical device 1. The optical receiver incorporates therein at least the optical receiver element 56. The TIA 57 amplifies the electrical signal that is obtained by the electrical conversion, and outputs the amplified electrical signal to the DSP 52. The DSP 52 performs processing, such as decoding, on the electrical signal that is acquired from the TIA 57, and obtains reception data.

Meanwhile, for the sake of simplicity of explanation, the example has been described in which the optical transceiver 50 incorporates therein an optical module 53 including the optical modulator element 54 and the optical receiver element 56, but the optical transceiver 50 may be an optical transmitter that incorporates therein only the optical modulator element 54 or an optical receiver that incorporates therein only the optical receiver element 56, and appropriate modification may be made.

Furthermore, the components of each of the units illustrated in the drawings need not always be physically configured in the manner illustrated in the drawings. In other words, specific forms of distribution and integration of each of the units are not limited to those illustrated in the drawings, and all or part of the units may be functionally or physically distributed or integrated in arbitrary units depending on various loads or use conditions.

Moreover, all or an arbitrary part of various kinds of processing functions that are implemented by the apparatuses may be realized by a Central Processing Unit (CPU) (or a microcomputer, such as a Micro Processing Unit (MPU) or a Micro Controller Unit (MCU)). Furthermore, all or an arbitrary part of the various kinds of processing functions may be implemented by a program that is analyzed and executed by the CPU, or may be realized by hardware using wired logic.

According to one aspect, it is possible to prevent a change of a tap rate even when a wavelength of signal light is changed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
a first coupler that includes
a first input port;
a first bar port that is located in a bar direction with respect to the first input port; and
a first cross port that is located in a cross direction with respect to the first input port, and
largely taps signal light on a short wavelength side from the first input port to the first bar port;
a second coupler that includes
a second input port;
a second bar port that is located in a bar direction with respect to the second input port; and
a second cross port that is located in a cross direction with respect to the second input port, and
largely taps signal light on a long wavelength side from the second input port to the second cross port; and
a monitor that is connected to one of the first bar port and the second cross port, and monitors the signal light that is output from one of the first bar port and the second cross port.

2. The optical device according to claim 1, wherein the first cross port of the first coupler is connected to one of a first input port of a different first coupler and a second input port of the second coupler.

3. The optical device according to claim 1, wherein the second bar port of the second coupler is connected to one of the first input port of the first coupler and a second input port of a different second coupler.

4. The optical device according to claim 1, wherein a first arrival time of the signal light from the first input port of the first coupler to the monitor and a second arrival time of the signal light from the first input port to the monitor via the second cross port of the second coupler coincide with each other.

5. The optical device according to claim 1, wherein
the first coupler includes
a first waveguide that serves as the first input port to input the signal light; and
a second waveguide that is adjacent to the first waveguide and enables optical coupling with the first waveguide by an evanescent wave,
the signal light is output from the second waveguide as the first cross port, and
the signal light on the short wavelength side is largely tapped from the first waveguide as the first bar port.

6. The optical device according to claim 1, wherein
the second coupler includes
a first waveguide that serves as the second input port to input the signal light; and
a second waveguide that is adjacent to the first waveguide and enables optical coupling with the first waveguide by an evanescent wave,
the signal light is output from the first waveguide as the second bar port, and
the signal light on the long wavelength side is largely tapped from the second waveguide as the second cross port.

7. The optical device according to claim 1, wherein
the first coupler includes
a first waveguide that serves as the first input port to input the signal light; and
a second waveguide that is adjacent to the first waveguide,
in a section in which the first waveguide and the second waveguide are arranged parallel to each other, a waveguide width of a first waveguide at a start point of the section and a waveguide width of a second waveguide at an end point of the section are equal to each other,
a waveguide width of the first waveguide at the end point and a waveguide width of the second waveguide at the start point are equal to each other,
the first waveguide and the second waveguide have point symmetrical structures,
the signal light is output from the second waveguide as the first cross port, and
the signal light on the short wavelength side is largely tapped from the first waveguide as the first bar port.

8. The optical device according to claim 1
the second coupler includes
a first waveguide that serves as the second input port to input the signal light; and
a second waveguide that is adjacent to the first waveguide,
in a section in which the first waveguide and the second waveguide are arranged parallel to each other, a waveguide width of a first waveguide at a start point of the section and a waveguide width of a second waveguide at an end point of the section are equal to each other,
a waveguide width of the first waveguide at the end point and a waveguide width of the second waveguide at the start point are equal to each other,
the first waveguide and the second waveguide have point symmetrical structures,
the signal light is output from the first waveguide as the second bar port, and
the signal light on the long wavelength side is largely tapped from the second waveguide as the second cross port.

9. An optical transmitter comprising:
an optical modulator element that modulates an optical signal by using an electrical signal, wherein
the optical transmitter transmits signal light that is modulated by the optical modulator element,
an optical device in the optical transmitter includes
a first coupler that includes
a first input port;
a first bar port that is located in a bar direction with respect to the first input port; and
a first cross port that is located in a cross direction with respect to the first input port, and
largely taps signal light on a short wavelength side from the first input port to the first bar port;
a second coupler that includes
a second input port;
a second bar port that is located in a bar direction with respect to the second input port; and
a second cross port that is located in a cross direction with respect to the second input port, and
largely taps signal light on a long wavelength side from the second input port to the second cross port; and
a monitor that is connected to one of the first bar port and the second cross port, and monitors the signal light that is output from one of the first bar port and the second cross port.

10. An optical receiver comprising:
an optical receiver element that acquires signal light from received light by using an optical signal, and performs electrical conversion on the acquired signal light, wherein
an optical device in the optical receiver includes
a first coupler that includes
a first input port;
a first bar port that is located in a bar direction with respect to the first input port, and
largely taps signal light on a short wavelength side from the first input port to the first bar port;
a second coupler that includes
a second input port;
a second bar port that is located in a bar direction with respect to the second input port; and
a second cross port that is located in a cross direction with respect to the second input port, and
largely taps signal light on a long wavelength side from the second input port to the second cross port; and
a monitor that is connected to one of the first bar port and the second cross port, and monitors the signal light that is output from one of the first bar port and the second cross port.
